(19) United States
(12) Patent Application Publication
(10) Pub. No.: US 2014/0353466 A1
(43) Pub. Date: Dec. 4, 2014

(54) Ice Cube Tray

(71) Applicant: United Comb & Novelty Corporation, Leominster, MA (US)

(72) Inventors: Rebecca B. Foster, West Lebanon, NH (US); David E. Zephir, Westminster, MA (US); Ronald Audet, North Smithfield, RI (US)

(73) Assignee: United Comb & Novelty Corporation, Leominster, MA (US)

(21) Appl. No.: 14/275,208

(22) Filed: May 12, 2014

Related U.S. Application Data
(60) Provisional application No. 61/822,469, filed on May 13, 2013.

(51) Int. Cl. F25C 1/04; F25C 1/22; F25C 1/24

(52) U.S. Cl. CPC F25C 1/04; F25C 1/243; F25C 1/22; B29L 2031/757
USPC 249/203

(57) ABSTRACT

An ice cube tray with a number of generally semi-circular depressions arranged in a number of columns and rows, with a number of depressions in each column and each row, wherein each depression is surrounded by a rim, and a shoulder formed in each rim. The shoulders are constructed and arranged to support part of the sidewall and/or bottom of a depression of another identical tray placed on top of the tray.

### CROSS-REFERENCE TO RELATED APPLICATION

This application claims benefit from U.S. Provisional Patent Application No. 61/822,469, filed May 13, 2013, the contents of which are incorporated herein by reference.

### BACKGROUND

Plastic ice cube trays generally make cubes that have a generally rectangular prism shape. In order to remove the cubes the tray must be twisted to break the cubes from all five generally rectangular walls of the tray depression—the four generally vertical sides and the bottom. This is difficult, and often causes the cubes to fracture.

### SUMMARY

Disclosed herein is an ice cube tray in which individual cubes can be easily removed by pressing down on them with a single finger. The tray is constructed and arranged such that multiple trays can be nested together in one orientation, and in a different orientation the trays can support one another such that they can be stacked in a freezer.

Featured herein is an ice cube tray comprising a plurality of generally semi-circular depressions arranged a number of columns and rows, with a plurality of depressions in each column and each row, wherein each depression is surrounded by a rim, and a shoulder formed in each rim, where the shoulders are constructed and arranged to support part of the sidewall and/or bottom of a depression of another identical tray placed on top of the tray.

In one aspect the depressions making up each column are aligned along a columnar axis and the columnar axes are parallel. Each depression may define a central longitudinal axis that is perpendicular to a columnar axis, where the depressions in adjacent rows are slightly offset from one another in the direction along the columnar axis such that the central longitudinal axes of depressions in adjacent columns are not co-linear but the central longitudinal axes of depressions in the same row in every other column are co-linear. Each rim may have only one shoulder. The shoulders in the rims of the depressions in each column may be on the same sides of the depressions. The shoulders in the rims of the depressions in adjacent column may be on opposite sides of the depressions. The depressions may have two parallel long sidewalls, where the long sidewalls are angled outwardly from the vertical. The outward angle may be at least about seven degrees.

The depressions and shoulders may be constructed and arranged such that two vertically aligned identical trays in one orientation nest one within the other and in an opposite orientation the trays are stacked such that the bottom tray supports the top tray in a manner in which the depressions of the top tray do not extend below the shoulders of the bottom tray.

Further featured is an ice cube tray with a plurality of generally semi-circular depressions arranged a number of columns and rows, with a plurality of depressions in each column and each row, wherein each depression is surrounded by a rim, wherein the depressions making up each column are aligned along a columnar axis and the columnar axes are parallel, and wherein each depression defines a central longitudinal axis that is perpendicular to a columnar axis, where the depressions in adjacent rows are slightly offset from one another in the direction along the columnar axis such that the central longitudinal axes of depressions in adjacent columns are not co-linear but the central longitudinal axes of depressions in the same row in every other column are co-linear, wherein the depressions have two parallel long sidewalls, where the long sidewalls are angled outwardly from the vertical at an angle of at least about seven degrees. A shoulder is formed in each rim, where the shoulders are constructed and arranged to support part of the sidewall and/or bottom of a depression of another identical tray placed on top of the tray, wherein each rim has only one shoulder, the shoulders in the rims of the depressions in each column are on the same sides of the depressions and the shoulders in the rims of the depressions in adjacent column are on opposite sides of the depressions. The depressions and shoulders are constructed and arranged such that two vertically aligned identical trays in one orientation nest one within the other and in an opposite orientation the trays are stacked such that the bottom tray supports the top tray in a manner in which the depressions of the top tray do not extend below the shoulders of the bottom tray.

### BRIEF DESCRIPTION OF THE DRAWINGS

A non-limiting embodiment of the ice cube tray is shown in the drawings, in which:

FIGS. 1A and 1B are top and bottom perspective views of an ice cube tray.

FIG. 2 is a top view of an ice cube tray.

FIG. 3A is a cross-sectional view of two trays taken along line 3-3 of FIG. 2, and FIG. 3B shows the two trays in the stacked configuration.

FIG. 4 is a partial close-up cross-sectional view illustrating how one tray supports another.

FIG. 5 is a cross-sectional view showing three nested trays with one tray stacked on top.

FIGS. 6A-6D are top and cross-sectional views of a tray including certain dimensions.

FIGS. 7A-7D are top, side, end and perspective views, respectively, of an ice cube made using the tray illustrated in FIGS. 1 through 6.

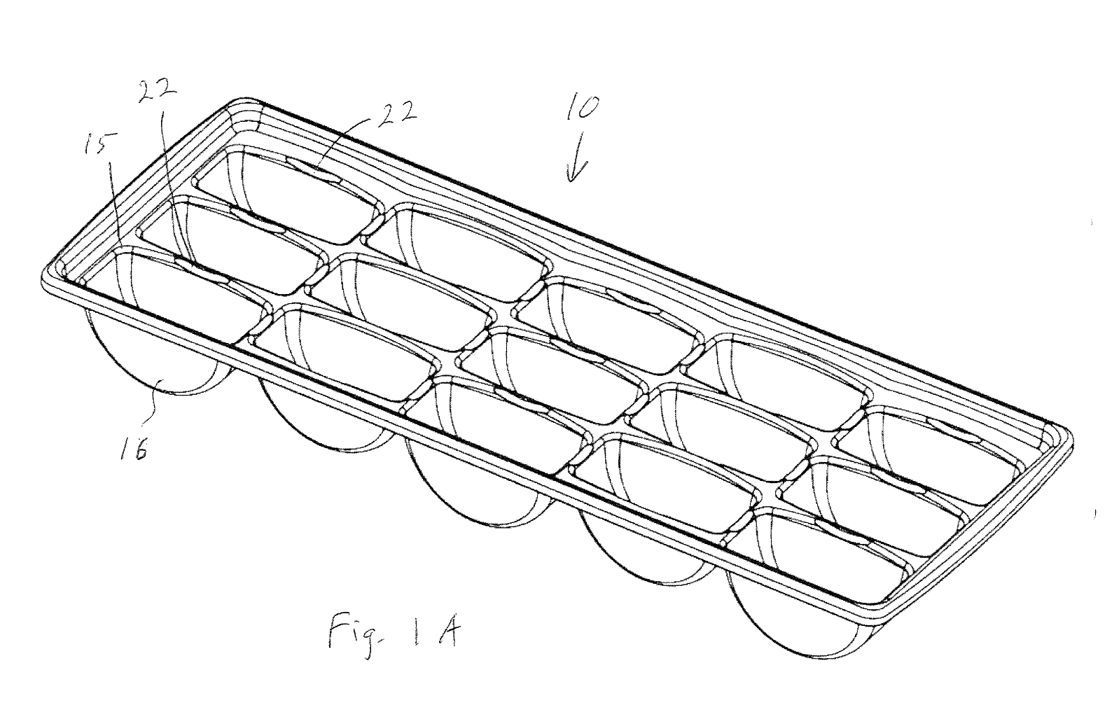

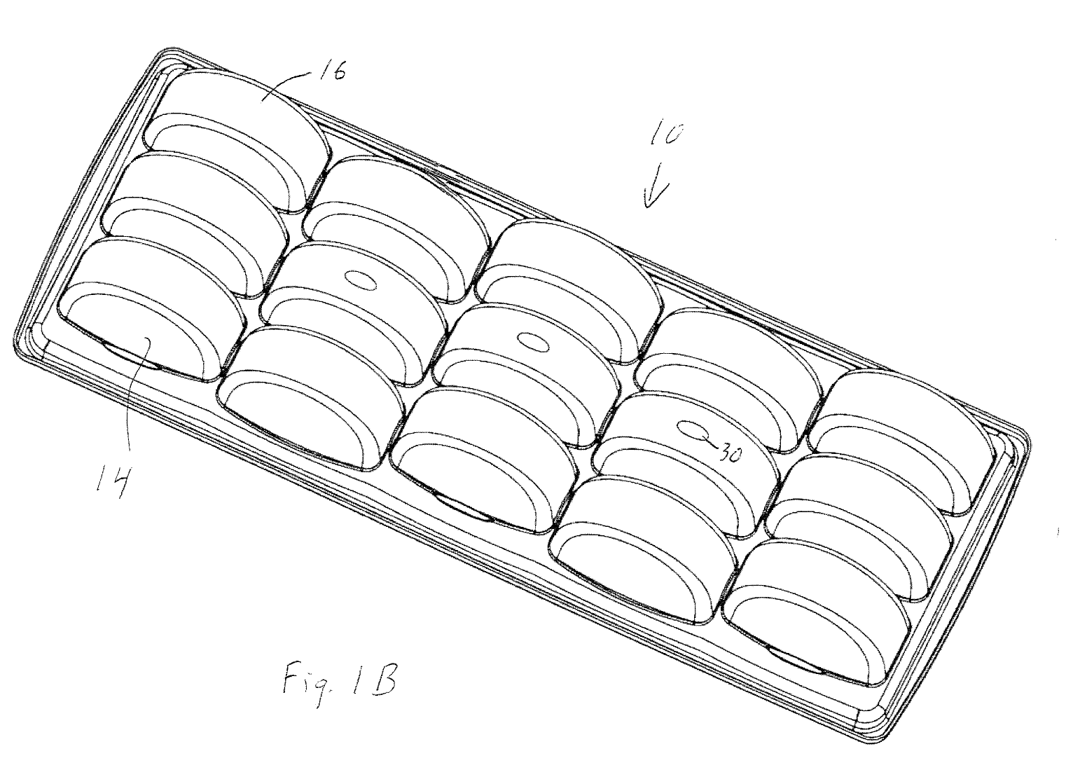

### DESCRIPTION OF EXAMPLES

Ice cube tray 10 is a molded plastic article of commerce that defines a number of generally semi-circular depressions that are constructed and arranged to be filled with water, which is frozen to create ice cubes. The depressions are arranged in a number of columns and rows. There are multiple depressions in each column and each row. Each depression is bordered by a rim that includes a shoulder that is constructed and arranged to support the bottom of a depression of another identical tray that is placed on top of the tray and in the opposite orientation, as explained below. When the top tray is rotated 180° from this stacked orientation, the depressions in the two trays are aligned so that the two trays can be nested together, e.g., for storage purposes.

Tray 10 includes fifteen generally semi-circular depressions each of which is defined in part by a rim 15 that surrounds the top opening of the depression. There can be a greater number or fewer depressions. There can be a greater number or fewer columns and/or rows. There can be a greater number or fewer depressions in each column and/or row. On one long side of each rim 15 there is a shoulder 22 that has an arc shape that matches the curved transitional region 20 between the sidewall and bottom of one side of a depression. Shoulders 22 support a tray placed on top of another tray so that the trays can be stacked in one orientation, as further described below.

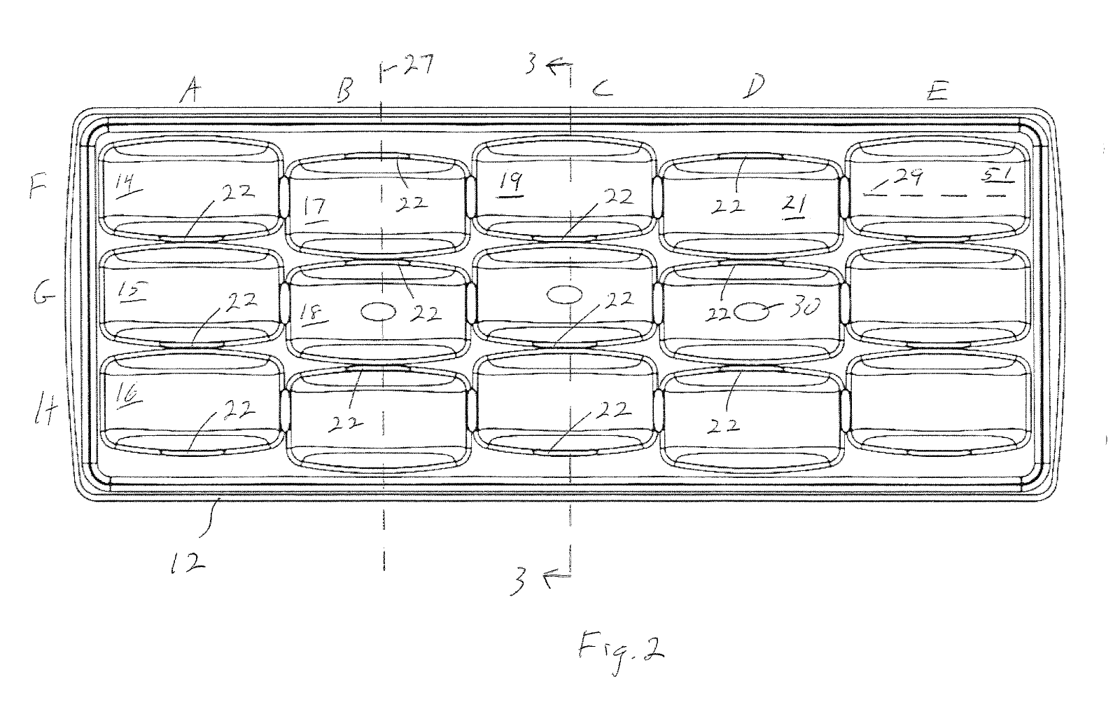

FIG. 2 is a top view of tray 10 and helps to further explain this stacking feature. The ice cube forming depressions are arranged in a number of columns. In this non-limiting example there are five columns labeled A-E. The depressions are arranged a number of rows. In this example there are three rows labeled F-H. The depressions making up each column are aligned along a columnar axis such as axis 27 of column B. The columnar axes are parallel. Each depression also defines a central longitudinal axis that is perpendicular to a columnar axis. For example, longitudinal axis 29 of depression 51 is illustrated in FIG. 2. The depressions in adjacent rows are slightly offset from one another in the direction along the columnar axis. As a result, the central longitudinal axes of depressions in adjacent columns are not co-linear. For example, the central longitudinal axes of depressions 14 and 17 of columns A and B are not co-linear. However, the central longitudinal axes of depressions in the same row in every other column are co-linear. Thus, the central longitudinal axes of the depressions in each of the rows of columns A, C and E are co-linear, as are those of columns B and D. For example, the central longitudinal axes of depressions 14, 19 and 51 are co-linear. Also, the central longitudinal axes of depression 17 and 21 are co-linear.

Because of this offset of adjacent columns of depressions and the existence of shoulders 22, when two identical trays are placed one above another, depending on their orientation the trays can be nested together such that the depressions fit one with another or they can be stacked such that the bottom tray supports the top tray in a manner in which the depressions of the top tray do not extend below the shoulders of the bottom tray.

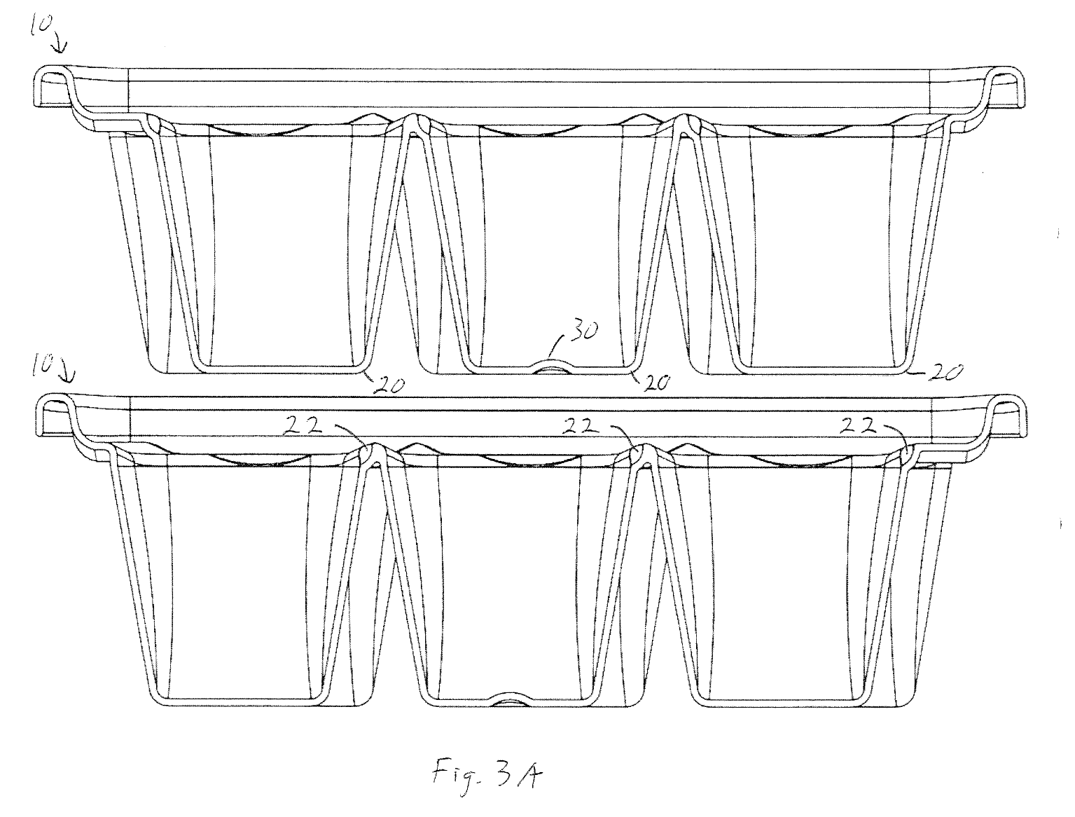

The stacking relationship is shown in FIGS. 3A, 3B and 4, where the curved transitional region 20 between the sidewall and bottom of a depression sits in shoulder 22 of a bottom depression. When the top tray orientation is rotated 180° from the position of tray 10 shown in FIG. 2, the depressions of the two trays are misaligned and thus regions 20 of the depressions of the upper tray naturally sit in the shoulders 22 of the lower tray to create the stacked orientation shown in FIG. 3B. The depression of the lower tray can be filled up to height 71 without being encroached by the bottom 73 of the upper tray. This allows two or more trays to be stacked so that multiple ice cube trays can be stacked up while taking up a floor area of the freezer equal to only that of a single tray.

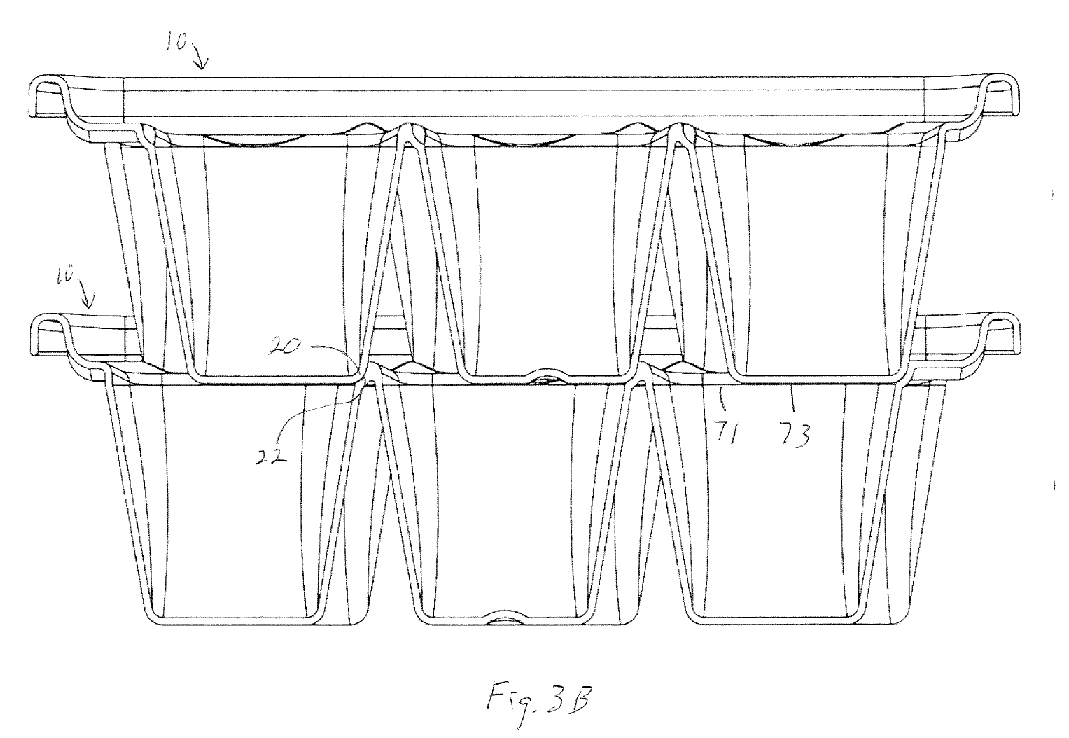

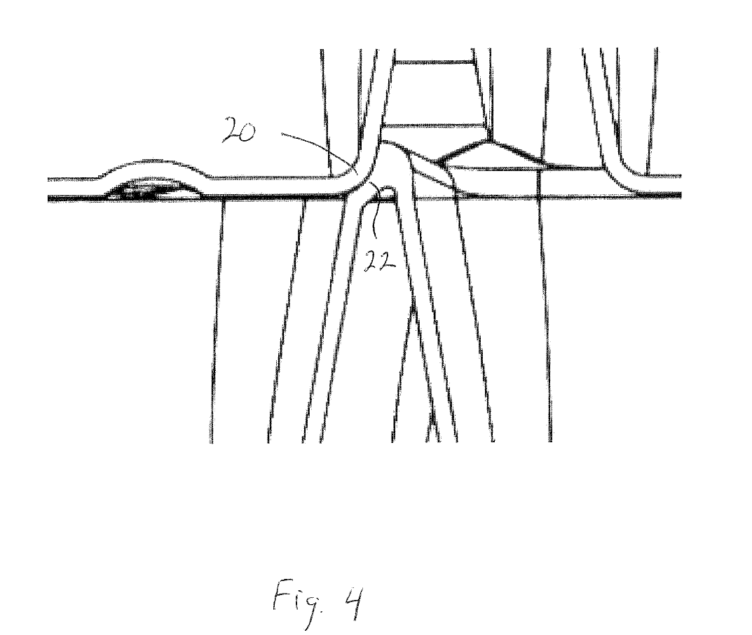

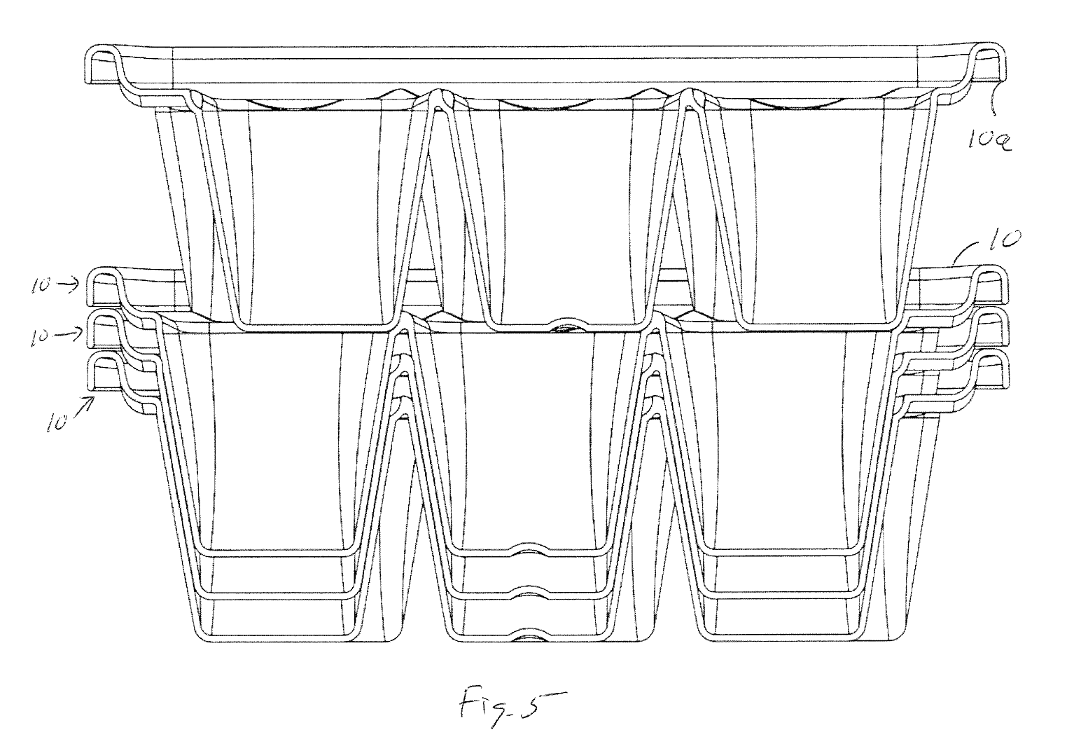

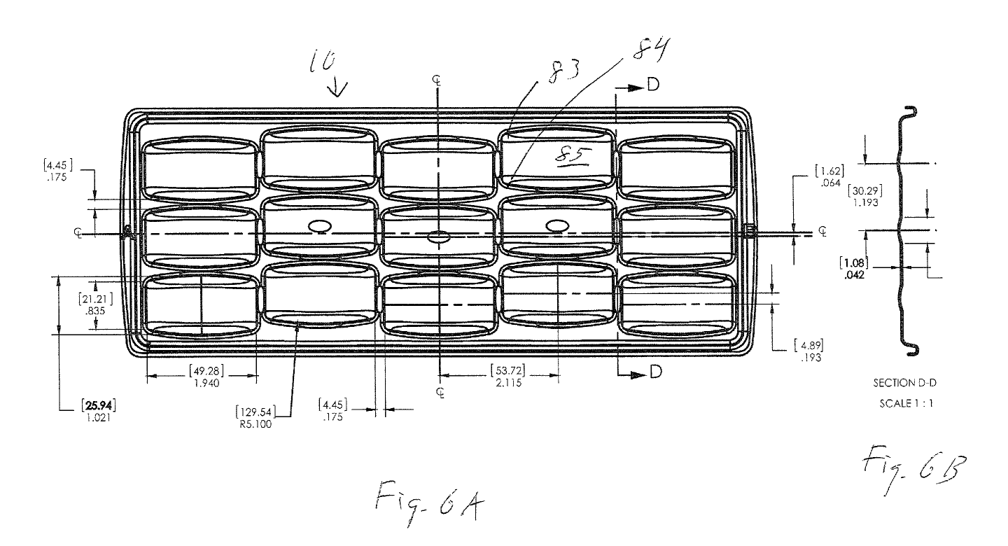

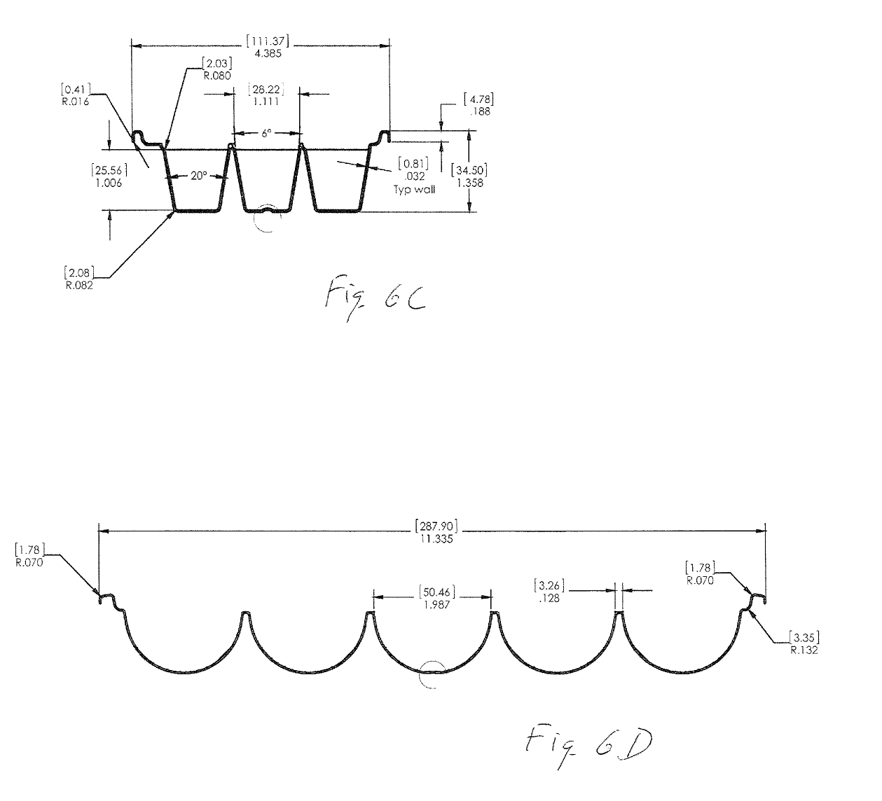

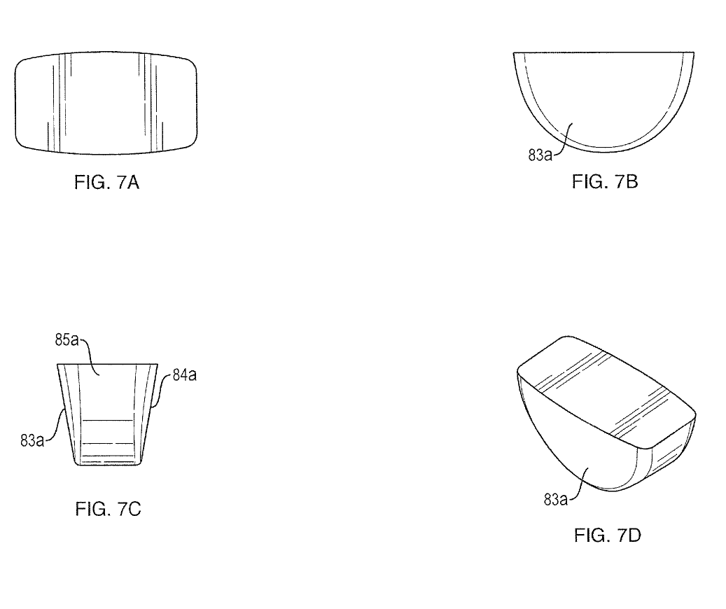

When two trays are oriented in the same manner, in other words two trays are oriented for example as shown in FIG. 2, the depressions of the trays are exactly aligned. This allows the depressions to fit within one another so that the trays can be nested as shown by the bottom three trays 10 in FIG. 5 (which also shows a top tray 10a stacked on top of the three nested trays). Removal of nested trays from each other is facilitated by tapering the flat sidewalls of the depressions, for example as shown by sidewalls 83 and 84 of depression 85, FIG. 6A. The resulting walls 83a and 84a of ice cube 85a that is made in depression 85 are shown in FIG. 7. Dimensions (in inches and in some cases equivalents in millimeters) and constructional details of tray 10 are shown FIG. 6. Features 30 located in three of the depressions are injection molding gate features that do not contribute to the ice cube-making functionality of the tray.

The cubes can be pushed out of a tray by pushing down with one finger on one side of the cube. It is believed that the cubes release easily due to the semi-circular profile that allows a cube to rotate about the circular center as it is pushed down on one side. The semi-circular shape is not required, though. It is believed that if the sides 91 and 92 are curved and flare outwardly from the vertical by at least about 7° (and thus are “generally semi-circular”) the cube will release from the tray as it is pushed down with a finger. An angle of 10 degrees per side (20 degrees total) is illustrated in FIG. 7, for both long sides and the generally semi-circular radius. This helps to release the cube from the tray. Also the depth of the depression (about one inch) contributes to the release of the cube; if the depression is deeper the cube will not release easily. If the depression is shallower the cube will release, but the cube may be too small to be acceptable in the marketplace.

Certain aspects of the disclosure are illustrated and described. However, these aspects illustrate the scope of the invention rather than limiting it to the particular illustrated examples. The scope of the invention is supported by the following claims.

What is claimed is:

1. An ice cube tray, comprising:
a plurality of generally semi-circular depressions arranged a number of columns and rows, with a plurality of depressions in each column and each row, wherein each depression is surrounded by a rim; and
a shoulder formed in each rim, where the shoulders are constructed and arranged to support part of the sidewall and/or bottom of a depression of another identical tray placed on top of the tray.

2. The ice cube tray of claim 1 wherein the depressions making up each column are aligned along a columnar axis and the columnar axes are parallel.

3. The ice cube tray of claim 2 wherein each depression defines a central longitudinal axis that is perpendicular to a columnar axis, where the depressions in adjacent rows are slightly offset from one another in the direction along the columnar axis such that the central longitudinal axes of depressions in adjacent columns are not co-linear but the central longitudinal axes of depressions in the same row in every other column are co-linear.

4. The ice cube tray of claim 3 wherein each rim has only one shoulder.

5. The ice cube tray of claim 4 wherein the shoulders in the rims of the depressions in each column are on the same sides of the depressions.

6. The ice cube tray of claim 5 wherein the shoulders in the rims of the depressions in adjacent column are on opposite sides of the depressions.

7. The ice cube tray of claim 1 wherein the depressions have two parallel long sidewalls, where the long sidewalls are angled outwardly from the vertical.

8. The ice cube tray of claim 7 wherein the outward angle is at least about seven degrees.

9. The ice cube tray of claim 1 wherein the depressions and shoulders are constructed and arranged such that two vertically aligned identical trays in one orientation nest one within the other and in an opposite orientation the trays are stacked such that the bottom tray supports the top tray in a manner in which the depressions of the top tray do not extend below the shoulders of the bottom tray.

10. An ice cube tray, comprising:
a plurality of generally semi-circular depressions arranged a number of columns and rows, with a plurality of depressions in each column and each row, wherein each depression is surrounded by a rim, wherein the depressions making up each column are aligned along a columnar axis and the columnar axes are parallel, and wherein each depression defines a central longitudinal axis that is perpendicular to a columnar axis, where the depressions in adjacent rows are slightly offset from one another in the direction along the columnar axis such that the central longitudinal axes of depressions in adjacent columns are not co-linear but the central longitudinal axes of depressions in the same row in every other column are co-linear, wherein the depressions have two parallel long sidewalls, where the long sidewalls are angled outwardly from the vertical at an angle of at least about seven degrees;
a shoulder formed in each rim, where the shoulders are constructed and arranged to support part of the sidewall and/or bottom of a depression of another identical tray placed on top of the tray, wherein each rim has only one shoulder, the shoulders in the rims of the depressions in each column are on the same sides of the depressions and the shoulders in the rims of the depressions in adjacent column are on opposite sides of the depressions; and
wherein the depressions and shoulders are constructed and arranged such that two vertically aligned identical trays in one orientation nest one within the other and in an opposite orientation the trays are stacked such that the bottom tray supports the top tray in a manner in which the depressions of the top tray do not extend below the shoulders of the bottom tray.
